(19) United States
(12) Patent Application Publication
(10) Pub. No.: US 2019/0391349 A1
(43) Pub. Date: Dec. 26, 2019

(54) OPTICAL MODULE

(71) Applicant: Hisense Broadband Multimedia Technologies Co., Ltd., Qingdao (CN)

(72) Inventors: Jinlei CHEN, Qingdao (CN); Ruijuan ZHOU, Qingdao (CN); Yinlong LIU, Qingdao (CN); Baofeng SI, Qingdao (CN)

(21) Appl. No.: 16/454,592

(22) Filed: Jun. 27, 2019

Related U.S. Application Data
(63) Continuation of application No. PCT/CN2019/090646, filed on Jun. 11, 2019.

(30) Foreign Application Priority Data
Jun. 20, 2018 (CN) 201810637663.2

(51) Int. Cl. G02B 6/42

(52) U.S. Cl. CPC G02B 6/4283; G02B 6/428; G02B 6/424; G02B 6/4277

(57) ABSTRACT

An optical module includes a base, an optical fiber adapter having a chuck, an optical subassembly coupled with the optical fiber adapter and a first support over the base and connected with the chuck. The first support includes an insulating material. The first support is configured to support the optical fiber adapter to electrically isolate the base from the optical fiber adapter.

### CROSS-REFERENCE TO RELATED APPLICATIONS

This application is a continuation application of International Application No. PCT/CN2019/090646 filed on Jun. 11, 2019, which claims priority to Chinese Patent Application No. 2018106376632 filed on Jun. 20, 2018, the entire content of which is incorporated herein by reference.

### TECHNICAL FIELD

The present disclosure relates to an optical module.

### BACKGROUND

With performance improvement of an optical module, it is desired to perform insulated isolation between optical assemblies within the optical module and an outer shell of the optical module, thereby effectively improving electromagnetic interference test indexes, such as, Conducted Emission (CE), Electro-Static Discharge (ESD) and so on.

### SUMMARY

An aspect of the present disclosure is directed to an optical that comprises a base, an optical fiber adapter having a chuck, an optical subassembly coupled with the optical fiber adapter and a first support over the base and connected with the chuck. The first support comprises an insulating material. The first support is configured to support the optical fiber adapter to electrically isolate the base from the optical fiber adapter.

Another aspect of the present disclosure is directed to an optical module that comprises a base comprising a bottom plate and side plates in contact with the bottom plate. The optical module also comprises an optical fiber adapter having a chuck. The optical module further comprises an optical subassembly coupled with the optical fiber adapter. The optical module additionally comprises a support over the base and connected with the chuck. The support comprises an insulating material. This support is configured to support the optical fiber adapter. The support has a groove extending in a direction toward the bottom plate, and the chuck is configured to be fixed within the groove.

### BRIEF DESCRIPTION OF THE DRAWINGS

The accompanying drawings, which are incorporated in and constitute a part of the present description, illustrate example embodiments consistent with the present disclosure and serve to explain the principles of the present disclosure together with the description.

FIG. 1A is a first schematic diagram illustrating a partial structure of an optical module, in accordance with one or more embodiments.

FIG. 1B is a second schematic diagram illustrating a partial structure of an optical module, in accordance with one or more embodiments.

FIG. 2 is a schematic diagram illustrating a structure of optical assemblies within an optical module, in accordance with one or more embodiments.

FIG. 3A is an exploded schematic diagram illustrating an optical module, in accordance with one or more embodiments.

FIG. 3B is an exploded schematic diagram illustrating an optical module, in accordance with one or more embodiments.

FIG. 3C is an exploded schematic diagram illustrating an optical module, in accordance with one or more embodiments.

FIG. 4A is a schematic diagram illustrating a structure of a base of an optical module, in accordance with one or more embodiments.

FIG. 4B is a schematic diagram illustrating a local structure of an optical module, in accordance with one or more embodiments.

FIG. 4C is a schematic diagram illustrating a partial structure of an optical module, in accordance with one or more embodiments.

FIG. 4D is a schematic diagram illustrating a partial structure of the base shown in FIG. 4A, in accordance with one or more embodiments.

FIG. 4E is a top view illustrating a partial structure of the base shown in FIG. 4A, in accordance with one or more embodiments.

FIG. 5A is a schematic diagram illustrating a partial structure of an optical , in accordance with one or more embodiments.

FIG. 5B is a schematic diagram illustrating a partial structure of an optical module, in accordance with one or more embodiments.

FIG. 6A is a schematic diagram illustrating a structure of a first support of an optical module, in accordance with one or more embodiments.

FIG. 6B is a schematic diagram illustrating a structure of a first support of an optical module, in accordance with one or more embodiments.

FIG. 7A is a schematic diagram illustrating a structure of a second support of an optical module, in accordance with one or more embodiments.

FIG. 7B is a schematic diagram illustrating a structure of a second support of an optical module, in accordance with one or more embodiments.

The example embodiments of the present disclosure are clearly illustrated by the above accompanying drawings, which will be described below in more detail. The accompanying drawings and text descriptions are intended to explain the concept of the present disclosure for persons skilled in the art with reference to specific example embodiments, rather than limit the scope of the present disclosure in any manner.

### DETAILED DESCRIPTION OF THE EMBODIMENTS

Various embodiments will be described in detail herein with the examples thereof expressed in the drawings. When the following descriptions involve the drawings, like numerals in different drawings represent like or similar elements unless stated otherwise. The embodiments described in the following examples do not intend to represent all embodiments consistent with the present disclosure. On the contrary, they are examples of an apparatus and a method consistent with some aspects of the present disclosure described in detail in the appended claims.

The terms “including”, “having” and any variation thereof in the specification and claims of the present disclosure and the accompanying drawings are intended to encompass non-exclusive inclusion. For example, processes, methods, systems, products or devices including a series of steps or units are not limited to the listed steps or units, but optionally, include unlisted steps or units as well, or optionally, include other steps or units inherent to the processes, methods, products or devices as well.

In addition, the terms “first” and “second” are only used for description, and cannot be construed as indicating or implying relative importance or implicitly indicating the number of indicated technical features. Therefore, the features defined with “first” and “second” may explicitly or implicitly include at least one of the features.

It is to be understood in the description of the present disclosure that an orientation or positional relationship indicated by the terms such as “up”, “down”, “left” and “right” is an orientation or positional relationship as shown in the accompanying drawings and is used only for facilitating describing the present disclosure and simplifying the description, rather than indicating or implying that an indicated apparatus or element must have a specific orientation or must be configured and operated in a specific orientation, and thus cannot be construed as limiting the present disclosure.

In the present disclosure, the terms such as “install”, “connect”, “couple” and “fix” are to be broadly understood unless otherwise clearly stated and defined. For example, two elements may be fixedly connected, detachably connected, or integrated into one piece; two elements may be directly connected, indirectly connected by an intermediate medium, or internally communicated or mutually interacted, unless clearly defined otherwise. Persons of ordinary skill in the art may understand specific meanings of the above terms in the present disclosure according to a specific situation.

In the present disclosure, a first feature “above” or “under” a second feature may be direct contact of the first feature and the second feature, or indirect contact of the first feature and the second feature by an intermediate medium, unless clearly stated and defined otherwise. Further, the first feature “on”, “over” and “above” the second feature may refer to that the first feature is directly or obliquely above the second feature, or may only refer to that the first feature has a greater horizontal height the second feature. The first feature “under”, “beneath” and “below” the second feature may refer to that the first feature is directly or obliquely below the second feature, or may only refer to that the first feature has a smaller horizontal height than the second feature.

The technical solutions of the present disclosure will be described below with respect to several exemplary embodiments. In some embodiments, the following specific examples may be combined with each other, and same or similar concepts or processes will not be described repeatedly.

An outer shell of an optical module is usually made of a zinc alloy material due to requirements of the optical module for service life, heat dissipation and electromagnetic shielding. An optical fiber adapter connected with optical assemblies is usually made of a stainless-steel material due to requirements of the assemblies for strength and processing precision.

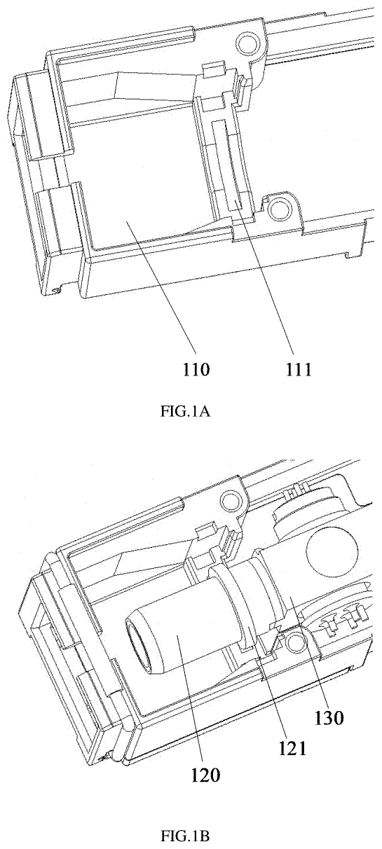

FIG. 1A is a first schematic diagram illustrating a partial structure of an optical module, in accordance with one or more embodiments. FIG. 1B is a second schematic diagram illustrating a partial structure of an optical module, in accordance with one or more embodiments. As shown in FIG. 1A and FIG. 1B, optical assemblies are fixed within an outer shell 110 by clamping a chuck 121 of an optical fiber adapter 120 into a groove 111 of the outer shell 110, the groove 111 and the outer shell 110 are integrally formed, and the optical assemblies include the optical fiber adapter 120 and an optical subassembly 130. Since the optical fiber adapter 120 and the outer shell 110 are both made of metal materials and the chuck 121 and the groove 111 are also made of metal materials, the optical fiber adapter 120 and the outer shell 110 of the optical module are in an electrically conducting state. That is, the optical assemblies are not electrically isolated from the outer shell 110 of the optical module.

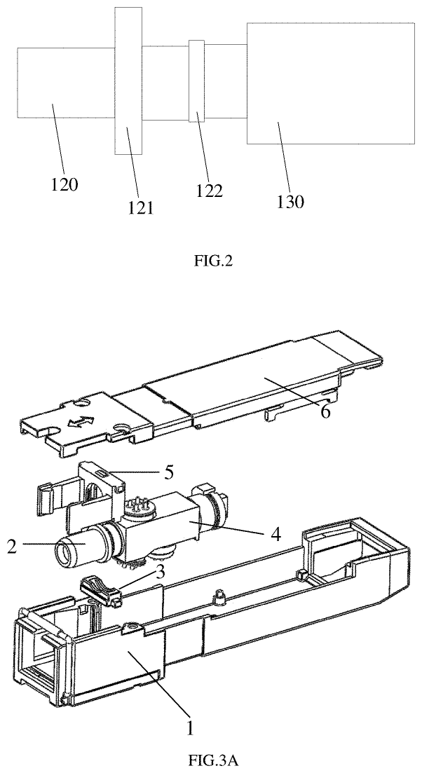

FIG. 2 is a schematic diagram illustrating a structure of optical assemblies within an optical module, in accordance with one or more embodiments. As shown in FIG. 2, to electrically isolate the optical fiber adapter 120 from the outer shell 110 of the optical module, on the basis of the optical module as shown in FIG. 1A and FIG. 1B, a ceramic sleeve 122 is added between the chuck 121 at a rear side of the optical fiber adapter 120 and the optical subassembly 130, thereby realizing electrical isolation between the optical fiber adapter 120 and the outer shell 110 of the optical module. However, the added ceramic sleeve 122 may increase an overall length of the optical assemblies, occupy the board arrangement space of a printed circuit board, or enlarge a length size of the optical module, and thus is disadvantageous for miniaturization design of the optical module and arrangement of relevant elements on the circuit board.

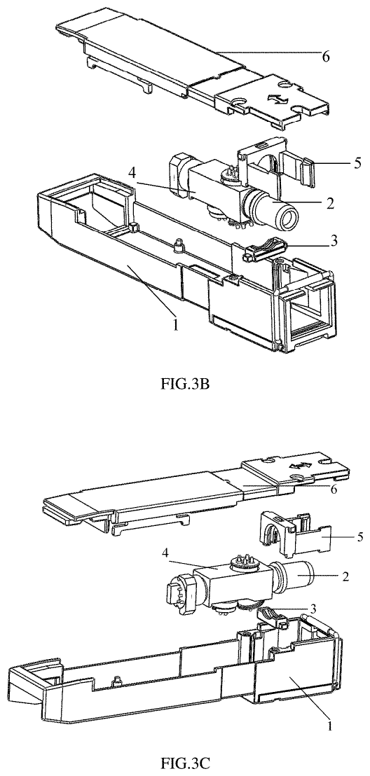

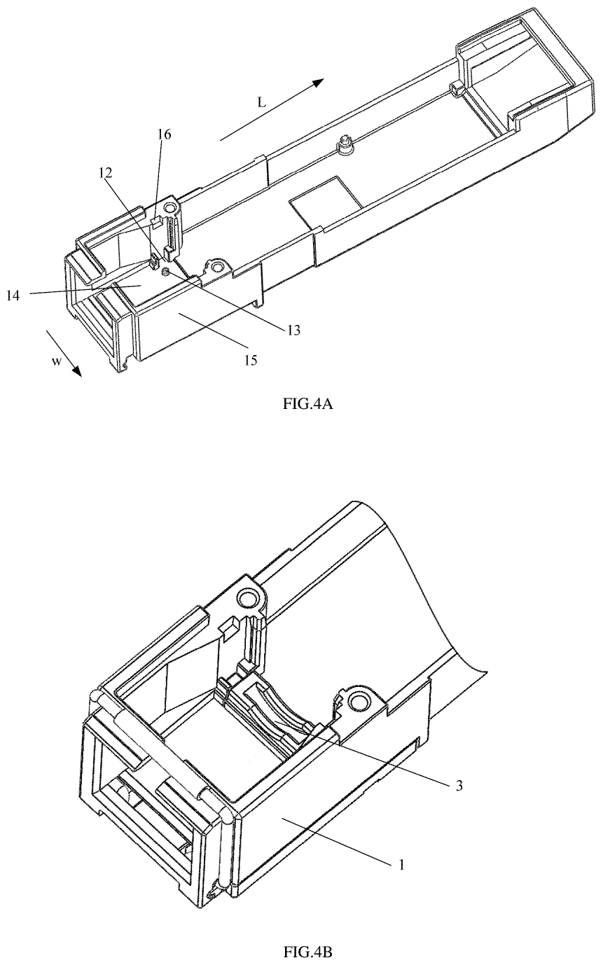

FIG. 3A is an exploded schematic diagram illustrating an optical module, in accordance with one or more embodiments. FIG. 3B is an exploded schematic diagram illustrating an optical module, in accordance with one or more embodiments. FIG. 3C is an exploded schematic diagram illustrating an optical module, in accordance with one or more embodiments. Specifically, FIG. 3A, FIG. 3B and FIG. 3C are all exploded schematic diagrams illustrating an optical module from different angles.

As shown in FIG. 3A, the optical module includes a base 1, a first support 3, an optical subassembly 4 and an optical fiber adapter 2. The optical subassembly 4 is connected with the optical fiber adapter 2, and the first support 3 is arranged on the base 1.

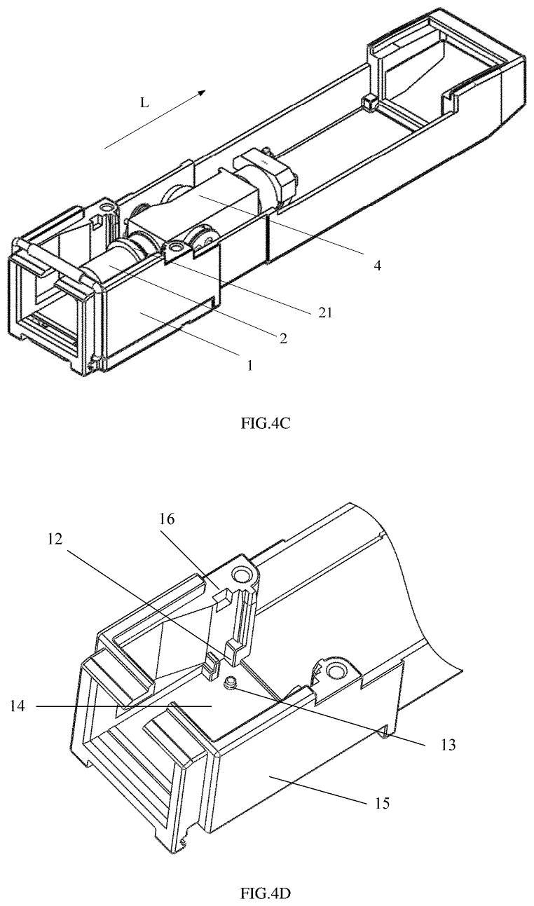

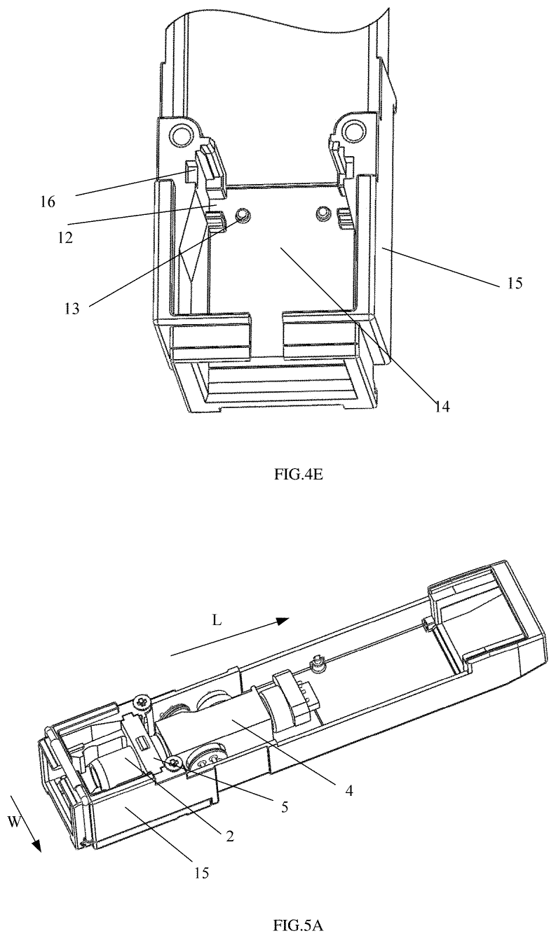

FIG. 4A is a schematic diagram illustrating a structure of a base of an optical module, in accordance with one or more embodiments. FIG. 4B is a schematic diagram illustrating a local structure of an optical module, in accordance with one or more embodiments. FIG. 4C is a schematic diagram illustrating a partial structure of an optical module, in accordance with one or more embodiments. FIG. 4D is a schematic diagram illustrating a partial structure of the base shown in FIG. 4A, in accordance with one or more embodiments. FIG. 4E is a top view illustrating a partial structure of the base shown in FIG. 4A, in accordance with one or more embodiments.

As shown in FIG. 4C, a chuck 21 arranged on the optical fiber adapter 2 is connected with the first support 3. In this case, the first support 3 supports the optical fiber adapter 2 such that the base 1 and the optical fiber adapter 2 are electrically isolated. The first support 3 is made of insulating material.

As shown in FIG. 4A, FIG. 4B and FIG. 4C, the first support 3 is arranged on the base 1, and the chuck 21 of the optical fiber adapter 2 is supported by the first support 3, thereby realizing the fixing of the optical assemblies, such as, the optical fiber adapter 2. The base 1 includes a bottom plate 14 and side plates 15 connected with the bottom plate 14. The first support 3 supports the optical fiber adapter 2 to allow the optical fiber adapter 2 to be electrically isolated from the bottom plate 14 and the side plates 15 respectively, thereby preventing an electromagnetic signal from the optical fiber adapter 2 from being transmitted to the outside through the directly-abutted bottom plate 14 and side plates 15.

In some embodiments, the optical assemblies of the present disclosure include the optical subassembly 4 and the optical fiber adapter 2.

The first support 3 is made of insulating material so that the optical fiber adapter 2 arranged on the first support 3 is electrically isolated from the base 1. The optical fiber adapter 2 is not abutted against the base 1 to isolate transmission of an electromagnetic signal, thereby realizing electrical isolation between the optical fiber adapter 2 and the base 1. Therefore, it is not required to arrange the ceramic sleeve 122 as shown in FIG. 2 between the optical fiber adapter 2 and the optical subassembly 4, and correspondingly, the size of the optical module in a length direction (as indicated by the “L” direction in FIG. 4A, i.e., a length direction of the bottom plate 14) will not be increased. The material of the first support 3 is, for example, a plastic material or a ceramic material.

The optical module according to various embodiments of the present disclosure includes the base 1, the first support 3, the optical subassembly 4 and the optical fiber adapter 2. The optical subassembly 4 is connected with the optical fiber adapter 2, the first support 3 is arranged on the base 1, a chuck 21 arranged on the optical fiber adapter 2 is connected with the first support 3, and the first support 3 supports the optical fiber adapter 2 to electrically isolate the base 1 from the optical fiber adapter 2. The first support 3 is made of insulating material. The optical fiber adapter 2 is supported and fixed by the first support 3 made of insulating material, so that the optical fiber adapter 2 supported by the first support 3 is electrically isolated from the base 1, thereby realizing the electrical isolation between the optical fiber adapter 2 and the base 1 of the optical module. In this manner, the electrical isolation is achieved without adding the ceramic sleeve 122 between the optical subassembly 4 and the optical fiber adapter 2, and an overall length of the optical assemblies is shortened, thereby ensuring the arrangement space for the circuit board at the rear and contributing to the miniaturization design of the optical module.

FIG. 5A is a schematic diagram illustrating a partial structure of an optical, in accordance with one or more embodiments. FIG. 5B is a schematic diagram illustrating a partial structure of an optical module, in accordance with one or more embodiments. As shown in FIG. 3A, FIG. 5A and FIG. 5B, the optical module may also include: an upper shell 6 operatively connected with the base 1 and a second support 5 The second support 5 is connected with the chuck 21 and abutted against the upper shell 6. The second support 5 is made of insulating material, so that the second support 5 may be used to electrically isolate the optical fiber adapter 2 from the base 1 and the upper shell 6 respectively. The first support 3 and the second support 5 are oppositely arranged along a direction that the bottom plate 14 points to the upper shell 6.

Specifically, as shown in FIGS. 3A-3C, the optical module includes the base 1, the first support 3, the optical assemblies (including an optical fiber adapter 2 and an optical subassembly 4), the second support 5, and the upper shell 6.

During assembly, as shown in FIGS. 4A-4C and FIGS. 5A-5B, the first support 3 is first placed on the base 1. Then, the chuck 21 on the optical fiber adapter 2 is connected with the first support 3 to place the optical fiber adapter 2 and the optical subassembly 4 connected with optical fiber adapter 2 on the first support 3. The second support 5 is then fixed on the chuck 21 of the optical fiber adapter 2.Next, the upper shell 6 is abutted against the second support 5 and connected with the base 1. The optical fiber adapter 2 and the optical subassembly 4 are arranged and fixed within the base 1 by the second support 5. In this way, precise coupling of the optical fiber adapter 2 and a ferrule of the optical subassembly 4 is realized by the fixing of the second support 5. In the optical module shown in FIG. 5B, the first support 3, the optical assemblies (including the optical fiber adapter 2 and the optical subassembly 4) and the second support 5 are electrically isolated within the optical module.

Compared with the solution shown in FIG. 2 in which electromagnetic isolation is realized by the ceramic sleeve 122, in the solution shown in FIGS. 3A-5B, a strength of the optical assemblies is effectively improved, design complexity of the optical device is reduced, a length of the optical device is effectively shortened, thereby satisfying a trend for miniaturization of the optical module.

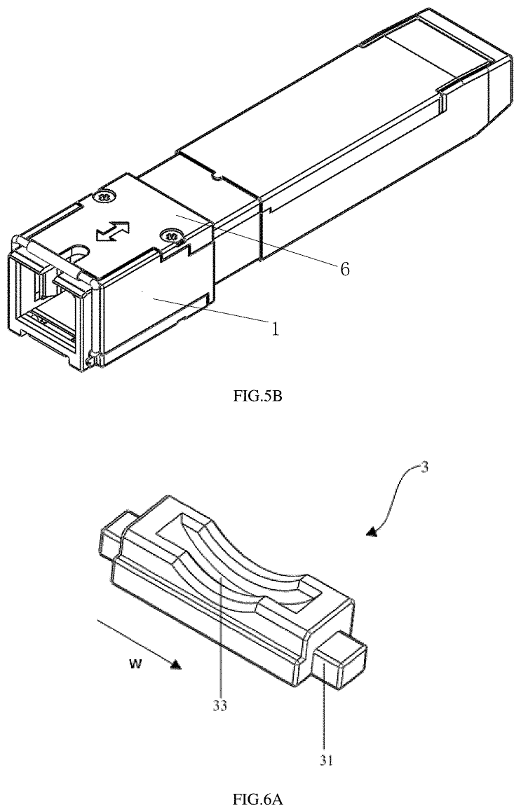

FIG. 6A is a schematic diagram illustrating a structure of a first support of an optical module, in accordance with one or more embodiments. On the basis of the above examples, to fix the first support 3 on the base 1, optionally, as shown in FIG. 4A and FIG. 6A, the base 1 includes the bottom plate 14 and the side plates 15 connected with the bottom plate 14, the bottom plate 14 or the side plates 15 are provided with a first positioning part 12, and the first support 3 is provided with a first clamping part 31. It is to be noted that one or more first positioning parts 12 may be configured. Correspondingly, one or more first clamping parts 31 may also be configured to mate with the one or more first positioning parts 12. The first positioning part 12 mates with the first clamping part 31 to limit a movement of the first support 3 along a length direction (as indicated by L direction shown in FIG. 5A) of the bottom plate 14. The side plates 15 connected with the bottom plate 14 is used to limit a movement of the first support 3 along a width direction (as indicated by W direction shown in FIG. 5A) of the bottom plate 14.

Specifically, as shown in FIG. 4A, the base 1 includes the bottom plate 14 and the side plates 15 connected with the bottom plate 14. Two side plates 15 are arranged in opposite direction. The bottom plate 14 or the side plates 15 is provided with the first positioning part 12. As shown in FIG. 6A, the first support 3 is provided with the first clamping part 31. During assembly, the first clamping part 31 arranged on the first support 3 is clamped into the first positioning part 12 within the base 1 corresponding to the first clamping part 31, so as to fix the first support 3, thereby limiting the movements of the first support 3 along the length direction and the width direction of the bottom plate 14. In FIG. 4A and FIG. 5A, the L direction refers to the length direction of the bottom plate 14, and the W direction refers to the width direction of the bottom plate 14.

In some embodiments, as shown in FIG. 6A, the first clamping parts 31 may be arranged at both sides of the first support 3 respectively. Correspondingly, as shown in FIG. 4E, the first positioning parts 12 may be arranged at a position within the base 1 corresponding to the first clamping parts 31. Further, the first clamping part 31 is a protruding block, and the first positioning part 12 is a groove. Alternatively, the first clamping part 31 is a groove, and the first positioning part 12 is a protruding block.

FIG. 6B is a schematic diagram illustrating a structure of a first support of an optical module, in accordance with one or more embodiments. In some embodiments, as shown in

FIG. 4A and FIG. 6B, to enhance firmness of the first support 3 within the base 1, the base 1 may be provided with a first fixing part 13, and the first support 3 may be provided with a first connecting part 32. It is to be noted that one or more first fixing parts 13 may be configured. Correspondingly, one or more first connecting parts 32 may also be configured to mate with one or more first fixing parts 13. The first fixing part 13 is connected with the first connecting part 32 to connect the first support 3 and the base 1.

Specifically, as shown in FIG. 4A and FIG. 6B, the first connecting part 32 may be arranged at a bottom of the first support 3, and the first fixing part 13 may be arranged at a position within the base 1 corresponding to the first connecting part 32. The first fixing part 13 is a positioning block, and the first connecting part 32 is a positioning hole. Alternatively, the first fixing part 13 is a positioning hole, and the first connecting part 32 is a positioning block.

During assembly, as shown in FIG. 4A and FIG. 6B, the first connecting part 32 (which is a positioning hole at this case) at the bottom of the first support 3 is sleeved on the first fixing part 13 on the base 1, and the first clamping parts 31 at both sides of the first support 3 are respectively clamped into the first positioning parts 12 within the base 1 corresponding to the first clamping parts 31, thereby firmly fixing the first support 3 within the base 1.

In some embodiments, when the first connecting part 32 is a positioning hole, the depth of which is less than a height of a body of the first support 3. The above positioning hole may be a “blind hole.” In some embodiments, a blind hole is, for example, a hole which has not been drilled through during drilling the hole on a material.

In some embodiments, the number of the first connecting parts 32 may be two, and two first connecting parts 32 are symmetrically arranged at the bottom of the first support 3.

Accordingly, the number of the first fixing parts 13 may also be two, and two first fixing parts 13 are symmetrically arranged on the base 1.

In some embodiments, to enhance stability of connection of the second support 5 and the upper shell 6, the upper shell 6 may be provided with a second fixing part, the second support may be provided with a second connecting part 56, and the second fixing part may be connected with the second connecting part 56 to fix the second support 5 and the upper shell 6. The second connecting part 56 may be fixed within the second fixing part. Specific arrangement of the second fixing part and the second connecting part 56 is similar to that of the first fixing part 13 and the first connecting part 32 described above, which will not be described herein.

In the above embodiments, both sides of the first support 3 along the length direction are provided with the first clamping parts 31 respectively, the first positioning parts 12 corresponding to the first clamping parts 31 are arranged within the base 1, the bottom of the first support 3 is provided with the first connecting part 32, and the first fixing part 13 corresponding to the first connecting part 32 is arranged within the base 1. During assembly, the first connecting part 32 at the bottom of the first support 3 is fixed on the first fixing part 13 within the base 1, and the first clamping parts 31 at both sides of the first support 3 are clamped into the first positioning parts 12 within the base 1 corresponding to the first clamping parts 31 respectively, thereby enhancing stability of the first support 3 and the base 1.

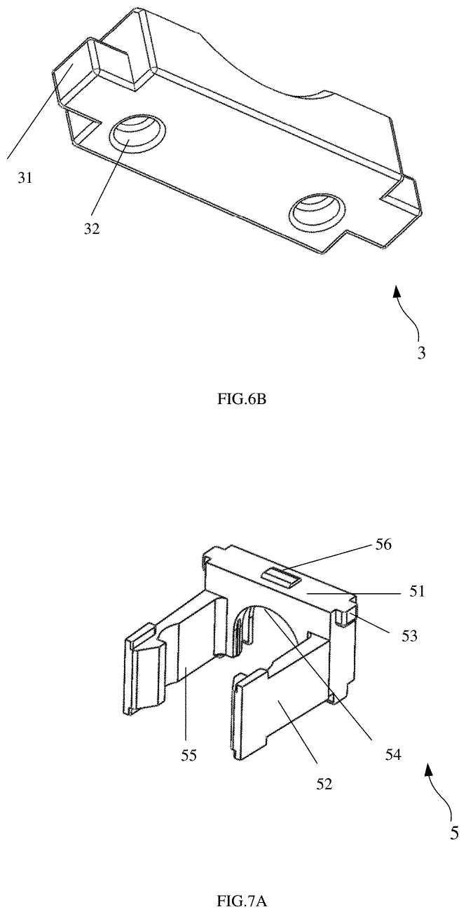

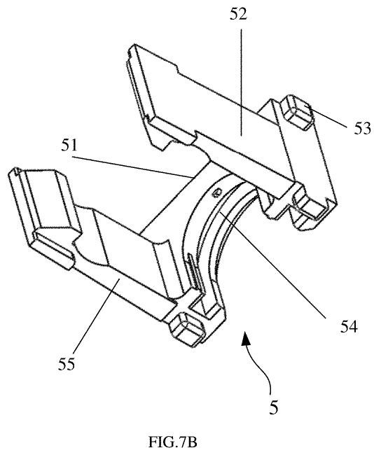

FIG. 7A is a schematic diagram illustrating a structure of a second support of an optical module, in accordance with one or more embodiments. FIG. 7B is a schematic diagram illustrating a structure of a second support of an optical module, in accordance with one or more embodiments. As shown in FIG. 4A, FIG. 5A, FIG. 7A and FIG. 7B, the second support 5 includes a beam 51, a first arm 52 and a second arm 55 which are arranged at both ends of the beam 51. The first arm 52 and the second arm 55 are abutted against the side plates 15. The second support 5 is provided with a second clamping part 53. The base 1 is provided with a second positioning part 16. It is to be noted that one or more second clamping parts 53 may be configured. Correspondingly, one or more second positioning parts 16 may also be configured to mate with the one or more second clamping parts 53. The second positioning part 16 is connected with the second clamping part 53 to limit a movement of the second support 5 along the length direction (as indicated by L direction shown in FIG. 5A) of the bottom plate 14. The side plates 15 connected with the bottom plate 14 limits a movement of the second support 5 along the width direction (as indicated by W direction shown in FIG. 5A) of the bottom plate 14.

As shown in FIG. 5A, FIG. 7A and FIG. 7B, FIG. 7A and FIG. 7B are schematic diagrams illustrating a second support from different angles. The second support 5 is abutted against the side plates 15 of the base 1 through the first arm 52 and the second arm 55 at both sides. The second support 5 mates with the second positioning part 16 of the base 1 through the second clamping part 53 to limit the movement of the second support 5 along the length direction of the bottom plate 14 of the base 1.

In some embodiments, the second positioning part 16 is arranged on the upper shell 6. Correspondingly, the second clamping part 53 is arranged at a position on the second support 5 corresponding to the second positioning part 16.

It is to be noted that the structure of the second support 5 shown in FIG. 7A and FIG. 7B is only described as an example. In some embodiments, the structure of the first arm 52 and the second arm 55 of the second support 5 may be adjusted according to the space within the base 1.

In some embodiments, as shown in FIG. 4E and FIG. 7A, the second positioning parts 16 may be arranged on the side plates 15 of the base 1, and the second clamping parts 53 may be arranged on the first arm 52 and the second arm 55 of the second support 5. In some embodiments, the second clamping part 53 is a protruding block, and the second positioning part 16 is a groove. Alternatively, the second clamping part 53 is a groove, and the second positioning part 16 is a protruding block.

In some embodiments, as shown in FIG. 5A, FIG. 6A and FIG. 7A, the first support 3 is provided with a first groove 33, the second support 5 is provided with a second groove 54, the chuck 21 arranged on the optical fiber adapter 2 is clamped within the space enclosed by the first groove 33 and the second groove 54, and the first groove 33 and the second groove 54 limit a movement of the optical fiber adapter 2 along the length direction (as indicated by L direction as shown in FIG. SA) of the bottom plate 14 to realize the fixing of the optical fiber adapter 2.

In some embodiments, as shown in FIG. SA, FIG. 7A and FIG. 7B, the second groove 54 is arranged on the beam 51, the first arm 52 and the second arm 55, the chuck 21 is clamped within the second groove 54, and the beam 51 and the first arm 52 and the second arm 55 are used to electrically isolate the optical fiber adapter 2 from the base 1 and the upper shell 6 respectively.

Specifically, the second groove 54 of the second support 5 is arranged on the beam 51, the first arm 52 and the second arm 55, and the chuck 21 of the optical fiber adapter 2 is clamped within the first groove 33 and the second groove 54, so that the optical fiber adapter 2 is electrically isolated from the base 1 and the upper shell 6 respectively.

In some embodiments, as shown in FIG. 5A and FIG. 7A, the beam 51 and the first support 3 are oppositely arranged, and the first arm 52 and the second arm 55 are arranged at both ends of the beam 51 along a length direction of the base 1 and abutted against the first support 3.

In the above embodiments, the specific structure of the second support 5 and how the second support 5 is fixed on the base 1 are described, and the optical fiber adapter 2 may be electrically isolated from the base 1 and the upper shell 6 respectively by the second support 5.

In some embodiments, insulating material may be provided between the optical subassembly 4 and both of the base 1 and the upper shell 6 after the optical fiber adapter 2 is electrically isolated from the base 1 and the upper shell 6 respectively.

Specifically, inner walls on the base 1 and the upper shell 6, corresponding to the upper and the lower of a round and square pipe of the optical subassembly 4, a transmitting side and a receiving side of the optical subassembly 4 are coated with a layer of insulating material, to avoid electrical conduction of the optical subassembly 4 and both of the base 1 and the upper shell 6. Insulating material is between the optical subassembly 4 and both of the base 1 and the upper shell 6.

Optionally, in some embodiments, the optical module further includes:

a Printed Circuit Board Assembly (PCBA) (not shown), wherein the transmitting side and the receiving side of the optical subassembly 4 are connected with the PCBA through a flexible circuit board.

The PCBA is insulated from the outer shell, and the outer shell includes the base 1 and the upper shell 6.

In some embodiments, the PCBA is insulated from the outer shell at a position in contact with the outer shell.

Specifically, the PCBA is connected with the optical subassembly 4 through the flexible circuit board. During circuit design, a position where the PCBA is in contact with the base 1 has no electrical property. That is, it is ensured that the PCBA is insulated from the base 1 to electrically isolate a whole interior of the optical module from the base 1.

In some embodiments, on the basis of realizing the insulating isolation of the optical fiber adapter 2 from the base 1 and the upper shell 6 respectively, the insulating material is provided between the optical subassembly 4 and both of the base 1 and the upper shell 6, and the PCBA is insulated from the outer shell at the position in contact with the outer shell, thereby electrically isolating the whole interior of the optical module from the base 1 and the upper shell 6.

In the descriptions of the present specification, terms such as “an example”, “some examples”, “illustrative examples”, “embodiments”, “some embodiments”, “a specific example”, “some examples” or the like are intended to refer to that a specific feature, structure, material, or characteristic described in combination with an embodiment or an example are included in at least one embodiment or example of the present disclosure. In the present specification, the illustrative expressions of the above terms do not necessarily refer to a same embodiment or example. Further, any specific feature, structure, material or characteristic described above may be combined in a proper way in one or more embodiments or examples.

The foregoing disclosure is merely illustrative of various embodiments or examples of the present disclosure, but not intended to limit the present disclosure, and any modifications, equivalent substitutions, adaptations thereof made within the spirit and principles of the disclosure shall fall within the scope of the present disclosure.

1. An optical module, comprising:
a base;
an optical fiber adapter having a chuck;
an optical subassembly coupled with the optical fiber adapter; and
a first support over the base and connected with the chuck, the first support comprising an insulating material, and being configured to support the optical fiber adapter to electrically isolate the base from the optical fiber adapter.

2. The optical module according to claim 1, wherein the base comprises:
a bottom plate; and
side plates in contact with the bottom plate,
wherein the first support is further configured to support the optical fiber adapter to electrically isolate the optical fiber adapter from the bottom plate and the side plates.

3. The optical module according to claim 2, wherein
the first support having a first groove;
the first groove is formed by recessing toward the bottom plate; and
the chuck is configured to be clamped within the first groove.

4. The optical module according to claim 3, further comprising:
an upper shell operatively connected with the base; and
a second support made of insulating material and comprising:
a beam; and
a first arm and a second arm arranged at both ends of the beam,
wherein the beam, the first arm and the second arm internally comprise a second groove, and the chuck is configured to be clamped within the second groove to electrically isolate the optical fiber adapter from the base and the upper shell through the beam, the first arm and the second arm.

5. The optical module according to claim 4, further comprising:
one or more second clamping parts arranged on the second support; and
one or more second positioning parts arranged on the base to mate with the one or more second clamping parts;
wherein the second positioning parts are configured to operatively connect with the second clamping parts to limit a movement of the second support along the length direction of the bottom plate, and
wherein the side plates are configured to limit a movement of the second support along the width direction of the bottom plate.

6. The optical module according to claim 5, wherein
the second positioning part is a protruding block, and
the second clamping part is a groove corresponding to the protruding block.

7. The optical module according to claim 5, wherein
the second positioning part is a groove, and
the second clamping part is a protruding block corresponding to the groove.

8. The optical module according to claim 4, further comprising:
one or more second clamping parts on the second support; and
one or more second positioning parts on the upper shell to mate with the one or more second clamping parts,
wherein the second positioning parts are configured to operatively connect with the second clamping parts to limit a movement of the second support along the length direction of the bottom plate, and
wherein the side plates are configured to limit a movement of the second support along the width direction of the bottom plate.

9. The optical module according to claim 4, wherein
the chuck is configured to be clamped within a space surrounded by the first groove and the second groove.

10. The optical module according to claim 4, wherein
the first support is opposite to the second support along a direction that the bottom plate points to the upper shell, and
ends of the first arm and the second arm are abutted against the first support.

11. The optical module according to claim 4, wherein insulating material is between the optical sub-module and both of the base and the upper shell.

12. The optical module according to claim 2, further comprising:
one or more first positioning parts on the bottom plate or the side plates; and
one or more first clamping parts on the first support and mated with the one or more first positioning parts,
wherein the first positioning parts are configured to operatively connect with the first clamping parts to limit a movement of the first support along a length direction of the bottom plate, and
wherein the side plates are configured to limit a movement of the first support along a width direction of the bottom plate.

13. The optical module according to claim 12, wherein
the first positioning part is a protruding block, and
the first clamping part is a groove corresponding to the protruding block.

14. The optical module according to claim 12, wherein
the first positioning part is a groove, and
the first clamping part is a protruding block corresponding to the groove.

15. The optical module according to claim 1, further comprising:
one or more first fixing parts on the base; and
one or more first connecting parts on the first support to mate with the one or more first fixing parts.

16. The optical module according to claim 15, wherein
the first fixing part is a positioning block, and
the first connecting part is a positioning hole corresponding to the positioning block.

17. The optical module according to claim 15, wherein
the first fixing part is a positioning hole, and
the first connecting part is a positioning block corresponding to the positioning hole.

18. An optical module, comprising:
a base, comprising a bottom plate and side plates in contact with the bottom plate;
an optical fiber adapter having a chuck;
an optical subassembly coupled with the optical fiber adapter; and
a support over the base and connected with the chuck, the support comprising an insulating material, and being configured to support the optical fiber adapter,
wherein the support has a groove extending in a direction toward the bottom plate, and the chuck is configured to be fixed within the groove.
